(19) United States
(12) Patent Application Publication
(10) Pub. No.: US 2026/0024370 A1
(43) Pub. Date: Jan. 22, 2026

(54) SPATIALLY ALIGNED STRING CONCATENATION SYSTEMS AND METHODS FOR IMPROVED OPTICAL CHARACTER RECOGNITION

(71) Applicant: State Farm Mutual Automobile Insurance Company, Bloomington, IL (US)

(72) Inventor: Carlos Ramirez Villamarin, New York, NY (US)

(21) Appl. No.: 18/779,808

(22) Filed: Jul. 22, 2024

(51) Int. Cl. G06V 30/40; G06V 10/25; G06V 30/10

(52) U.S. Cl. CPC G06V 30/43; G06V 10/25; G06V 30/10

(57) ABSTRACT

A spatial alignment computer system for string alignment within a document processed using an optical character recognition (OCR) tool is provided. The computer system includes a processor in communication with a memory, wherein the processor is programmed to receive a plurality of bounding boxes of a document scanned using an OCR tool, identify a centroid of each bounding box of the plurality of bounding boxes, calculate coordinates for each centroid of each bounding box of the plurality of bounding boxes using a weighted Euclidean distance approach, sort the weighted Euclidean distance of the centroid of each bounding box in ascending order to obtain a sorting index, and based upon the sorting index, align one or more output strings associated with each bounding box of the plurality of bounding boxes.

### FIELD OF THE DISCLOSURE

The present disclosure generally relates to optical character recognition (OCR), and, more particularly, to computer-based systems and methods configured to spatially align output strings resulting from an AI (artificial intelligence) OCR tool for subsequent performance evaluation.

### BACKGROUND

Optical character recognition (OCR) techniques are used in many fields, including, but not limited to, banking and finance, healthcare, insurance, legal, government, for generating digital documents from physical documents. OCR techniques generally involve a pre-processing stage, a text recognition stage, a post-processing stage, and an application-specific optimization stage. During the post-processing stage, an output stream such as a plain text stream or a file of characters is generated. However, in these known OCR techniques, during the post-processing stage, a layout of the output strings, or an alignment of the output strings, within the generated digital document may vary from an original layout of the scanned physical document. These known OCR techniques use a Levenshtein distance algorithm during the post-processing stage for optimization. However, different OCR tools or different versions of the same OCR tool can produce an output having a significantly different layout within the generated digital document due to different positional bounding box configurations including different numbers of bounding boxes and different sizes of the bounding boxes. As described herein, the term “bounding box” refers to a generally rectangular box that is described by a number of numerical coordinates for positioning the box within a document and encloses an optically detected word(s) or image within a document.

Accordingly, there exists a need for an OCR alignment system and method that spatially aligns output strings from two different OCR tools (e.g., either two different tools or two different versions of the same tool) so that the output strings from the different OCR tools are similarly aligned in the digital document and so that the outputs from the two different OCR tools can be compared.

### BRIEF SUMMARY

The present embodiments may relate to, inter alia, systems and methods that are configured to spatially align output strings resulting from an AI (artificial intelligence) OCR tool for subsequent performance evaluation. This spatial alignment system is configured to generate a digital document from a scanned physical or original document using any OCR tool wherein the output strings from any two different OCR tools (e.g., either two different tools or two different versions of the same tool) are similarly aligned in the digital document and more accurately represents the information included in the original document. The system and method described herein allows for improved comparisons between the outputs from different OCR tools. For example, if the spatial alignment system outputs strings using two different OCR versions that are generally aligned, then those two OCR tool versions may be considered compatible. If, however, the spatial alignment system outputs strings from two different OCR versions that are not aligned or have other differences, then those two OCR tool versions may be considered or labeled not compatible. And further review of the OCR tools may be needed to determine the cause of the differences between the outputs.

In the exemplary embodiment, the OCR tool outputs are organized by a post-processing system of the spatial alignment system in a JavaScript Object Notation (JSON) file according to the JSON file's structure. Any discrepancies in the JSON file's structure are generally handled in a rule or case-by-case basis. The spatial alignment system described herein uses natural ordering of reading for generating and aligning the output strings. By way of a non-limiting example, the natural ordering of reading may be an ordering of reading the English language, which is top-to-bottom and left-to-right. In the exemplary embodiment, the spatial alignment system obtains the natural ordering of reading by sorting centroids of identified bounding boxes according to their weighted Euclidean distance to a reference point of the physical document.

By way of an example, the reference point may include coordinates of the top-left corner point of the physical document. Further, in the example embodiment, vertical coordinates may be weighted more heavily than horizontal coordinates. With the alignment implementation described in the present disclosure, alignment of the output strings may be properly achieved each time the spatial alignment system is used, independent of the number of resulting bounding boxes and the respective positions or sizes of those boxes. Further, the Euclidean weights may be assigned to the centroids of the bounding boxes according to certain predefined document standards to ensure proper x-coordinate and y-coordinate locations. After alignment, the sets of one or more strings may be concatenated to generate or compute OCR performance metrics. In other words, the JSON file structure is ignored and a coordinate system that is further deformed by weights may generate the similarly aligned output strings irrespective of the OCR tool used to scan the physical document. Additionally, the embodiments of the spatial alignment system as described herein also include improving the computing system used to perform the post-processing tasks by requiring less processing time, and, thereby, improving the overall performance or capacity of the spatial alignment computing system. In those cases where the spatial alignment system outputs strings from two different OCR versions that are not aligned or have other differences between them (e.g., the number 0 being recognized as the letter O), then those two OCR tool versions may be considered or labeled not compatible, and further review of the OCR tools may be needed.

In one aspect, a spatial alignment computer system for string alignment within a document processed using an OCR tool may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the spatial alignment computer system may include at least one memory and at least one processor in communication with the at least one memory. The at least one processor may be programmed to: (i) receive a plurality of bounding boxes of a document scanned using an OCR tool; (ii) identify a centroid of each bounding box of the plurality of bounding boxes; (iii) calculate coordinates for each centroid of each bounding box of the plurality of bounding boxes using a weighted Euclidean distance approach; (iv) sort the weighted Euclidean distance of the centroid of each bounding box in ascending order to obtain a sorting index; and (v) based upon the sorting index, align one or more output strings associated with each bounding box of the plurality of bounding boxes. The computer system may include additional, less, or alternate functionality, including that discussed elsewhere herein.

In another aspect, a computer-implemented method for string alignment within a document processed using an OCR tool may be provided. The method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer-implemented method may be implemented using a computer device including at least one processor in communication with the at least one memory. The method may include: (i) receiving a plurality of bounding boxes of a document scanned using an OCR tool; (ii) identifying a centroid of each bounding box of the plurality of bounding boxes; (iii) calculating coordinates for each centroid of each bounding box of the plurality of bounding boxes using a weighted Euclidean distance approach; (iv) sorting the weighted Euclidean distance of the centroid of each bounding box in ascending order to obtain a sorting index; and (v) based upon the sorting index, aligning one or more output strings associated with each bounding box of the plurality of bounding boxes. The computer-implemented method may include additional, less, or alternate functionality, including that discussed elsewhere herein.

In yet another aspect, at least one non-transitory computer-readable storage medium (CRM) with instructions stored thereon for string alignment within a document processed using an OCR tool may be provided. The computer device that processes these instructions may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the instructions, when executed by the at least one processor of the computer device, may cause the at least one processor to: (i) receive a plurality of bounding boxes of a document scanned using an OCR tool; (ii) identify a centroid of each bounding box of the plurality of bounding boxes; (iii) calculate coordinates for each centroid of each bounding box of the plurality of bounding boxes using a weighted Euclidean distance approach; (iv) sort the weighted Euclidean distance of the centroid of each bounding box in ascending order to obtain a sorting index; and (v) based upon the sorting index, align one or more output strings associated with each bounding box of the plurality of bounding boxes. The at least one CRM may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

Certain example embodiments are shown in the drawing arrangements discussed herein. However, it should be understood that the present embodiments are not limited to the precise arrangements and/or instrumentalities shown herein.

FIG. 1 depicts exemplary layouts of a physical document generated using the spatial alignment system including two different OCR tools in accordance with the present disclosure.

FIG. 2 depicts an exemplary page layout of a digital document corresponding to a physical page generated by the spatial alignment system in accordance with the present disclosure.

FIG. 3 depicts an exemplary table showing page measurements for various predefined paper sizes used by the spatial alignment system in accordance with the present disclosure.

FIG. 4A depicts an exemplary page layout corresponding to a distribution of bounding boxes identified using the spatial alignment system and an OCR tool in accordance with the present disclosure.

FIG. 4B depicts an exemplary page layout with output strings aligned using a weighted Euclidean distance calculation and the spatial alignment system in accordance with the present disclosure.

FIG. 4C depicts an exemplary page layout with output strings aligned using a standard Euclidean distance calculation and the spatial alignment system in accordance with the present disclosure.

FIG. 4D depicts a graph showing a CPU time comparison using lexicographic ordering and weighted Euclidean distance ordering schemes in accordance with the present disclosure.

FIG. 5 depicts an exemplary configuration of a user device or a user equipment that may be in communication with the spatial alignment system in accordance with the present disclosure.

FIG. 6 depicts an exemplary configuration of an application server included within the spatial alignment system in accordance with the present disclosure.

FIG. 7 depicts a flow-chart of exemplary computer-implemented method operations implemented by the spatial alignment system including an OCR tool in accordance with the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, a network-based system and method that is configured to spatially align output strings resulting from an AI (artificial intelligence) OCR tool for subsequent performance evaluation including how the output from one version of an OCR tool matches up to the output of another version of an OCR tool. The spatial alignment system is configured to generate a digital document from a scanned physical or original document using any OCR tool wherein the output strings from any two different OCR tools (e.g., either two different tools or two different versions of the same tool) are similarly aligned in the digital document and more accurately represents the information included in the original document. The system and method described herein allows for improved comparisons between the outputs from different OCR tools. In particular, the digital documents are generated with output strings that are similarly aligned as compared to the physical document regardless of the OCR tool used for scanning the physical document, and without regard to the JSON file configuration or structure that is outputted from the OCR tool including the number of bounding boxes and sizes of bounding boxes. The output strings are similarly aligned in the generated digital documents using a coordinate system that is further deformed by weights.

For example, if the spatial alignment system outputs strings or bounding boxes using two different OCR versions that are generally aligned, then those two OCR tool versions may be considered compatible. If, however, the spatial alignment system outputs strings or bounding boxes from two different OCR versions that are not aligned or have other differences, then those two OCR tool versions may be considered or labeled not compatible and further review of the OCR tools may be needed to determine the cause of the differences between the outputs.

As described herein, a “bounding box” may refer to a generally rectangular box that includes an object and a set of data points. The bounding box defines an area on the X and Y axes that encloses an image or text. It is used when using an OCR tool.

When using machine learning (ML) and AI tools, it is important to monitor both the unstructured data used and the AI tools that process it. In particular, when evaluating AI tools for Optical Character Recognition (OCR), it is necessary that output strings resulting from the AI OCR tool are correctly aligned (within the document) for subsequent performance calculations. This alignment is challenging because different AI OCR tools, or different version of the same tool, may lead to different positional string configurations including a different number and sizes of bounding boxes associated with each string.

The spatial alignment system and method described herein are configured to perform spatial alignment of strings within a document by utilizing a weighted Euclidean distance calculation with respect to a refence point. This unique and novel approach to aligning OCR outputs ensures that, given two OCR outputs from different AI tools, versions, or coordinate systems, alignment is still attained every time, enabling the system to monitor and evaluate the AI OCR tools. If, however, the spatial alignment system outputs strings from two different OCR versions that are not aligned or have other differences between the outputs, then those two OCR tool versions may be considered or labeled not compatible and further review of the OCR tools may be needed to determine the cause of the differences between the outputs.

The spatial alignment systems and methods described herein include a mathematical approach to generating spatial alignment of strings within a digital document that is created using an AI OCR tool. The alignment is driven by a weighted coordinate system, which allows fast string alignment on documents for OCR monitoring and evaluation. More specifically, in order to obtain a consistent string alignment within a digital document, the system follows the natural ordering induced by English language reading: top/down and left/right. To accomplish this, centroids of bounding boxes are sorted according to their weighted Euclidean distance to the origin of coordinates (top left of the document). In this case, vertical coordinates are weighted more heavily than horizontal coordinates, allowing the system to more closely mimic the human English reading pattern. Given two OCR outputs, the system and method include three primary steps: (i) compute the weighted Euclidean distance to each centroid of the bounding box; (ii) sort distances in ascending order and obtain the sorting indexing; and (iii) align the strings according to the sorting indexing computed in step (ii).

### Exemplary Layouts of A Physical Document Generated Using Two Different OCR Tools

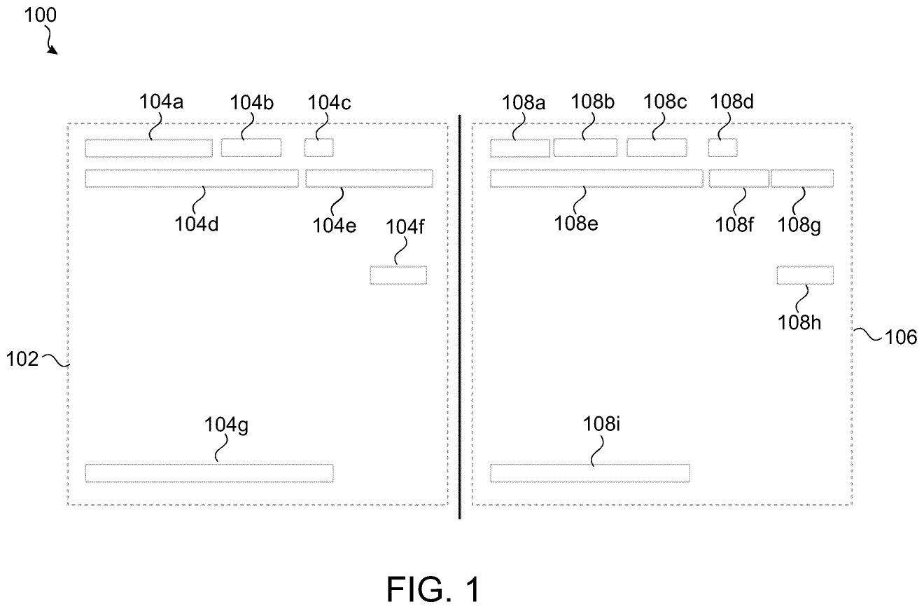

FIG. 1 depicts an exemplary side-by-side comparison 100 of a page scanned using two different OCR tools, or two different versions of the same OCR tool. Accordingly, a first OCR tool or a first version of an OCR tool may have identified output strings as bounding boxes 104a-104g for a scanned page shown in FIG. 1 as 102. Similarly, a second OCR tool or a second version of the OCR tool may have identified output strings as bounding boxes 108a-108i for a scanned page shown in FIG. 1 as 106. Properties of bounding boxes 104a-104g and 108a-108i may include a respective size and shape of the bounding box, in addition to a location of the bounding box on the scanned page. As shown in FIG. 1, the scanned pages 102 and 106 have at least a different number of bounding boxes identified for the same page. Additionally, or alternatively, locations of the bounding boxes or spacing between the bounding boxes may also be different in the scanned pages 102 and 106 depending upon the JSON file configuration of the OCR tool used regarding the number of bounding boxes and sizes of bounding boxes.

As described herein, the side-by-side comparison 100 and the alignment of the bounding boxes (104a-104g and 108a-108i) may be generated using the spatial alignment computer system, wherein the spatial alignment computer system may include the different OCR tools or different versions of the OCR tool, and wherein the spatially aligned output strings from two different OCR tools are similarly aligned in the output document.

Accordingly, the spatial alignment system is configured to spatially align output strings resulting from different versions of an AI OCR tool for subsequent performance evaluation and comparison between the different versions of the tool. This spatial alignment system is configured to generate a digital document from a scanned physical or original document using any OCR tool wherein the output strings from any two different OCR tools (e.g., either two different tools or two different versions of the same tool) are similarly aligned in the digital document and more accurately represents the information included in the original document. The system and method described herein allows for improved comparisons between the outputs from different OCR tools. For example, if the spatial alignment system outputs strings using two different OCR versions that are generally aligned, then those two OCR tool versions may be considered compatible. If, however, the spatial alignment system outputs strings from two different OCR versions that are not aligned or have other differences (e.g., reading the number 0 as the letter O), then those two OCR tool versions may be considered or labeled not compatible and further review of the OCR tools may be needed to determine the cause of the differences between the outputs.

### Exemplary Page Layout of a Digital Page Document Corresponding to a Physical Page Document

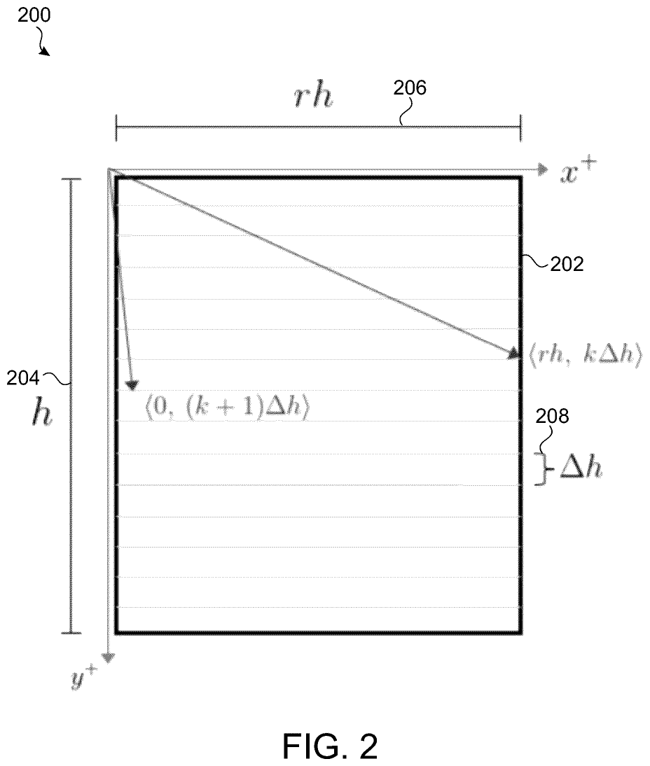

FIG. 2 depicts an exemplary page layout 200 of a digital page document 202 corresponding to a physical page document having physical measurements as shown in a table 300, which illustrates page measurements for various predefined page sizes. The page layout 200 may be generated using the spatial alignment computer system. Based on a page size (e.g., letter, legal, tabloid, ledger, junior legal, half letter, government letter, government legal, etc.), the physical page document may have a different height and a different width, as shown in the table 300. The digital page document 202 may have a height h 204 and a width rh 206 corresponding to the height and width of the physical page shown in the table 300. By way of a non-limiting example, a centroid of a bounding box identified using OCR techniques may be measured using a coordinate system having an origin or a reference point designated at the top-left corner of the digital page document.

Additionally, a vertical spacing between two consecutive lines may be Δh 208. Accordingly, coordinates of a rightmost point on the right edge of the digital document 202, as shown in FIG. 2, may be (rh, kΔh), where rh corresponds with the width of the digital document, k represents a number of lines or rows of texts from the top edge of the digital document 202. Similarly, coordinates of the a point on the left edge of the digital document 202 may be (0, (k+1)Δh), where 0 represents a distance of the point on the left edge of the digital document along a horizontal axis, and (k+1)Δh represents a distance of the point on the left edge of the digital document along a vertical axis from the origin or reference point. Coordinates of a centroid of each bounding box may be represented using the coordinate system, as described herein, with respect to FIG. 2.

As described herein, the page layout 200 of the digital page document 202 corresponding to the physical page document having physical measurements as shown in a table 300 may be generated including the coordinates and string alignments using the spatial alignment computer system.

### Exemplary Page Layout Alignment of Bounding Boxes and Output Strings Using Standard and Weighted Euclidean Distance Methods

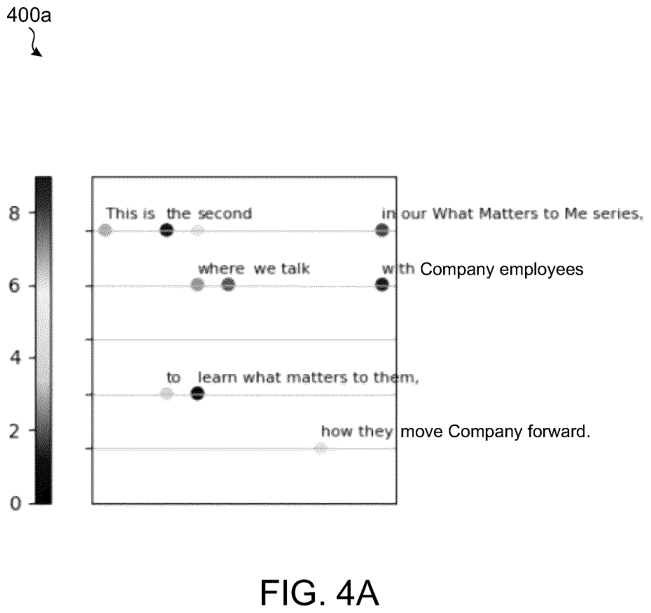

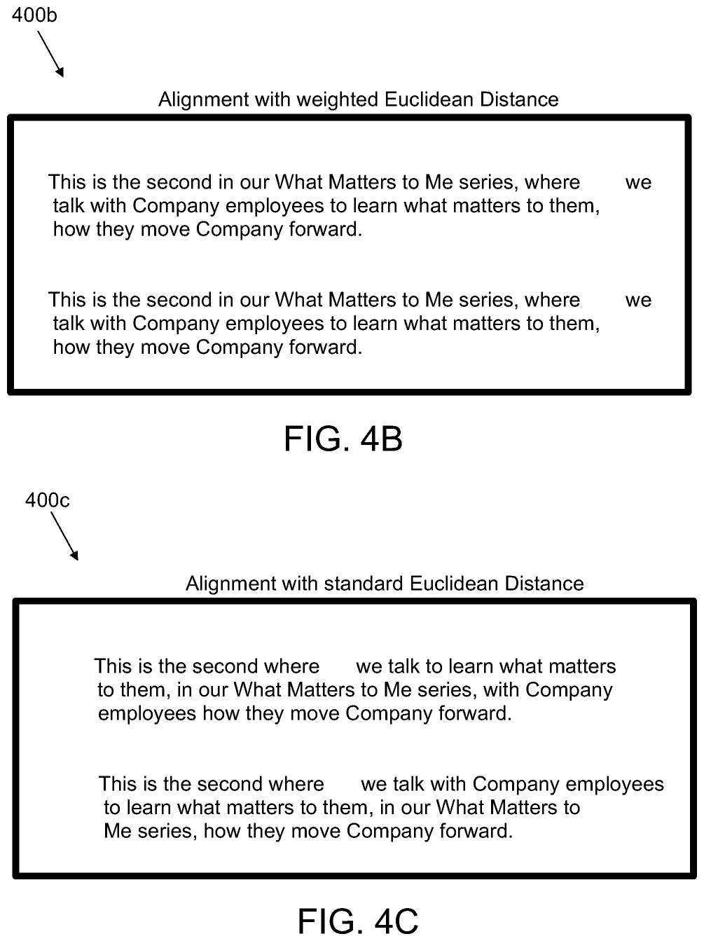

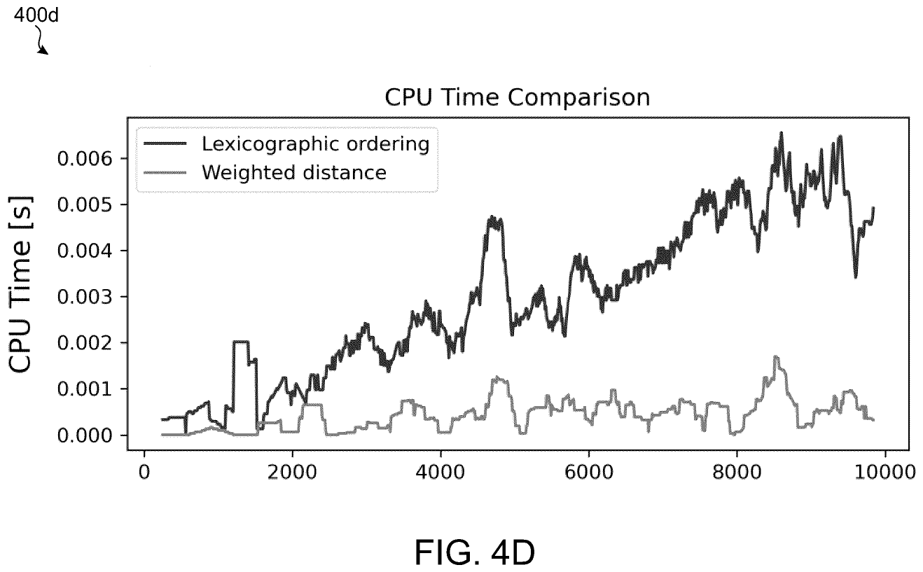

FIG. 4A depicts an exemplary page layout 400a corresponding to a distribution of centroids of bounding boxes identified using an OCR tool and the spatial alignment computer system. In FIG. 4A, various centroids of identified bounding boxes are represented as dots, and text identified in each bounding box from the scanning of the page using OCR technique is also shown. This page layout 400a may be generated using the spatial alignment computer system described herein.

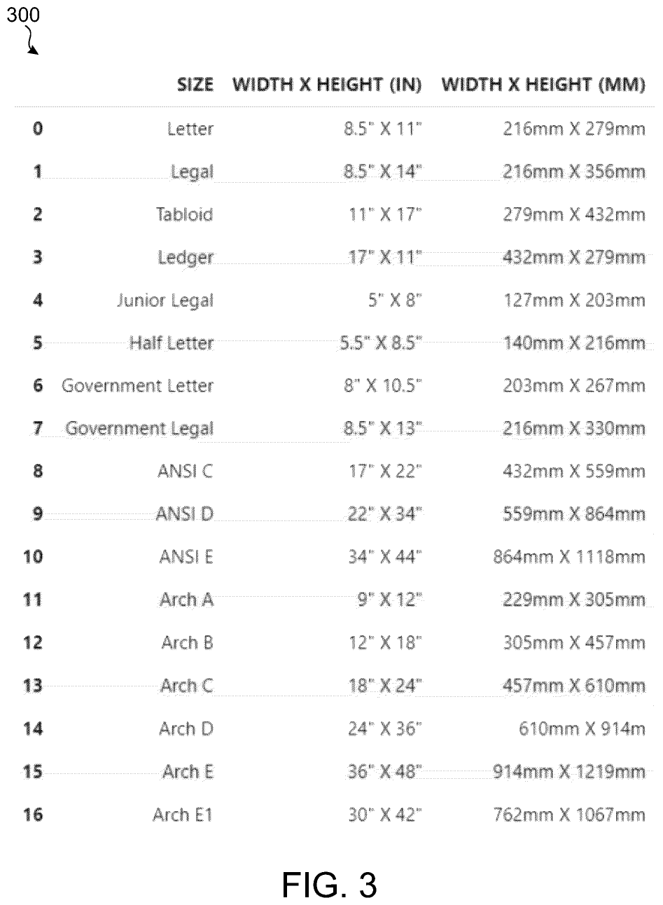

In some embodiments, in order to obtain a consistent string alignment within a document without regard to the OCR tool used to scan the physical document, the natural ordering of English language reading (e.g., top-down and left-right) is used by the spatial alignment system. Furthermore, the coordinates of centroids of the bounding boxes may be determined by the spatial alignment system as described herein using FIG. 2 and FIG. 3. The weighted Euclidean distance calculation for each centroid of the bounding boxes with reference to the origin or reference point (e.g., top-left point of the document 202, as shown in FIG. 2) may be calculated. The vertical coordinates are weighted more heavily than the horizontal coordinates while calculating the weighted Euclidean distance corresponding to the natural ordering of the English language reading pattern.

The weighted Euclidean distance calculated for each centroid of the bounding boxes may be sorted in ascending order by the spatial alignment system to obtain a respective sorting index for each bounding box. Based on the sorting index associated with each bounding box, strings identified corresponding to each bounding box may be assigned with a predetermined horizontal spacing between texts of each bounding box.

The weighted Euclidean distance may be defined as:

$$‖ x ‖ ω = \sqrt{{ω}_{1} {x}_{1}^{2} + {ω}_{2} {x}_{2}^{2}} , where {ω}_{1} and {ω}_{2} are positive real numbers \qquad Eq . 1$$

The weighted Euclidean distance as represented by Eq. 1 may be represented in terms of the classical Euclidean distance as:

$$‖ x ‖ ω = ‖ {ω}^{1 / 2} x ‖ , \qquad Eq . 2$$

In Eq. 2 above, ω^{1/2} is a diagonal matrix whose values in the main diagonal are \sqrt{ω₁} and \sqrt{ω₂}. In other words, ω^{1/2} is positive definite matrix.

As a result, the weighted Euclidean distance is a norm which satisfy the following three properties: (1)∥x∥ω=0 only if x=0; (2)∥ax∥ω=|α|∥x∥ω; and (3)∥x+y∥ω≤∥x∥ω+∥y∥ωω.

Referring to the page layout 200 shown in FIG. 2, with a length h and a width rh, an aspect ratio r may be

$$r = \frac{1}{\sqrt{2}} ,$$

and for all line numbers k where k is 1, 2, 3, . . . , n, to have ∥<rh, kΔh>∥<∥<0, (k+1)Δh>∥ω, a condition

$${ω}_{2} > {( \frac{r h}{Δ h} )}^{2} {ω}_{1}$$

needs to be satisfied.

In some embodiments, and by way of a non-limiting example, for a densely populated paper, narrow margin and single line spacing at 8 sized Calibri font in a paper of letter size, Δh is h/150, and, therefore, the approximate weight bound may be calculated as

$${ω}_{2} > {( \frac{1.55 h}{h} 150 )}^{2} {ω}_{1} ,$$

such that ω₂>54.056ω₁.

FIG. 4B depicts an exemplary page layout 400b with output strings aligned using the weighted Euclidean distance calculation and the spatial alignment computer system as described herein with respect to FIG. 4A, in accordance with one embodiment of the present disclosure. As shown in FIG. 4B, using the weighted Euclidean distance approach by the spatial alignment computer system, as described herein, strings corresponding to each identified bounding box may be aligned according to the natural ordering from English language reading.

FIG. 4C depicts an exemplary page layout 400c with output strings aligned using the standard Euclidean distance calculation and the spatial alignment computer system as described herein with respect to FIG. 4A, in accordance with one embodiment of the present disclosure. As shown in FIG. 4C, aligning strings corresponding to each identified bounding box using the standard Euclidean distance approach may result in a representation which may be different from the original page scanned using OCR techniques.

Accordingly, using the weighted Euclidean distance approach, as described herein, improves accuracy of the generated document using OCR techniques irrespective of the OCR tool or a version of the OCR tool.

FIG. 4D depicts an exemplary graph 400d showing a CPU time comparison using lexicographic ordering and weighted Euclidean distance ordering schemes. Based upon the graph 400d, it can be seen that the weighted Euclidean distance ordering scheme substantially improves the overall performance of a computing device by improving resource utilization.

### Exemplary User Equipment

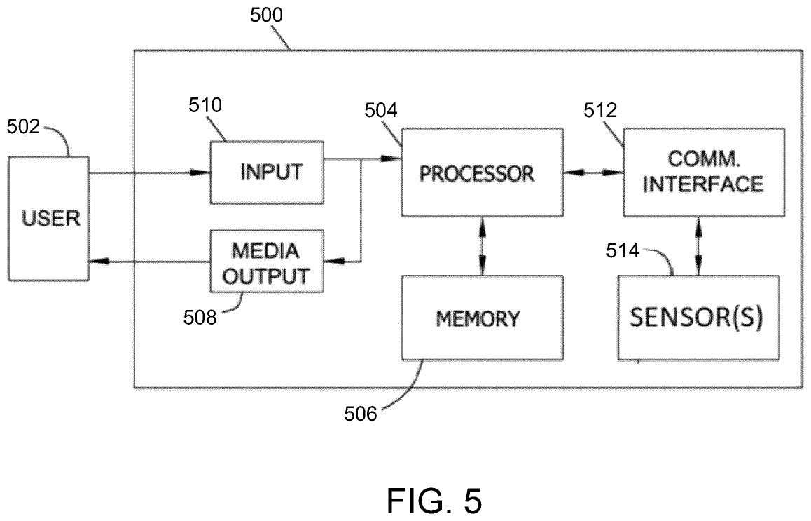

FIG. 5 depicts an exemplary configuration of a user equipment (or a user device) 500, in accordance with one embodiment of the present disclosure. The user equipment 500 may be, for example, a mobile device, smart home controller, a smart watch, smart contact lenses, augmented reality (AR) glasses, virtual reality (VR) headset, mixed or extended reality headset or glasses, wearables, voice or chat bot, an IoT device, other input device, and/or other electronic or electrical devices. The user device 500 may be in communication with the spatial alignment computer device, and may be part of the overall spatial alignment computer system.

The user equipment 500 may include a processor 504 for executing instructions. In some embodiments, executable instructions may be stored in a memory 506. Processor 504 may include one or more processing units (e.g., in a multi-core configuration). Memory 506 may be any device allowing information such as executable instructions and/or transaction data to be stored and retrieved. Memory 506 may include one or more computer readable media.

The user equipment 500 may also include at least one media output component 508 for displaying a dashboard or information to user. Media output component 508 may be any component capable of conveying information to a user 502. In some embodiments, media output component 508 may include an output adapter (not shown) such as a video adapter and/or an audio adapter. An output adapter may be operatively coupled to processor 504 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 508 may be configured to present a graphical user interface (e.g., a web browser and/or a client application) to the user 502. A graphical user interface may include, for example, an interface for viewing prompts and data. In some embodiments, the user equipment 500 may include an input 510 for receiving input from the user 502. The user 502 may use input 510 to, without limitation, provide user input.

Input device 510 may include, for example, a keyboard, a pointing device, a mouse, a stylus, a touch sensitive panel (e.g., a touch pad or a touch screen), a biometric input device, at least one vision sensor (e.g., a camera or a video camera), and/or an audio input device such as a microphone. A single component such as a touch screen display may function as both an output device of media output component 508 and input device 510.

The user equipment 500 may also include a communication interface 512, communicatively coupled to a backend system, an application server, and/or one or more servers. Communication interface 512 may include, for example, a wired or wireless network adapter and/or a wireless data transceiver for use with a network (e.g., a Wi-Fi network, an Internet, a 3G/4G/5G/6G network, a WiMAX network, etc.).

Stored in memory 506 are, for example, computer readable instructions for providing a user interface to the user via media output component 508 and, optionally, receiving and processing input from input 510. A user interface may include, among other possibilities, a web browser and/or a client application. Web browsers enable users, such as user 502, to display and interact with media and other information typically embedded on a web page or a website from the backend system. A client application (e.g., a frontend application executing on the user device 500) may allow the user 502 to interact with, for example, the backend system.

In some embodiments, the user equipment 500 may include one or more sensors 514. By way of a non-limiting example, the one or more sensors 414 may include, but is not limited to, a gyroscope, an accelerometer, a position detector, a temperature sensor, a lux sensor (or a light level sensor), a water level sensor, an air composition sensor, an image sensor, a voice/sound sensor, a pressure sensor, a humidity sensor, an accelerometer, an infrared sensor, a vibration sensor, and/or an ultrasonic sensor.

In some embodiments, generative artificial intelligence (AI) models (also referred to as generative machine learning (ML) models) may be utilized with the present embodiments, and the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by and/or used in conjunction with reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

### Exemplary Application Server

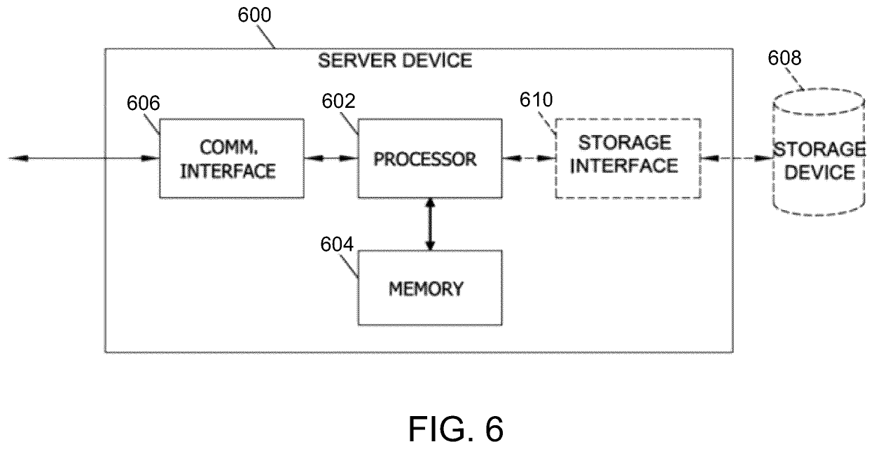

FIG. 6 depicts an exemplary configuration of an application server 600 of a backend system of the spatial alignment computer system, in accordance with one embodiment of the present disclosure. Application server 600 is part of the spatial alignment computer system and may be in communication with user device 500 (shown in FIG. 5). Application server 600 may be configured to perform various operations, as described herein, from the backend system perspective. Processor 602 may include one or more processing units (e.g., in a multi-core configuration). Processor 602 may be operatively coupled to a communication interface 606 such that the application server 600 is capable of communicating with a remote device, such as another application server 600, the user equipment 500, for example, via the network, using wireless communication or data transmission over one or more radio links or digital communication channels. For example, communication interface 606 may receive data, e.g., image, video, and/or text. By way of a non-limiting example, the application server 600 may be a server which may receive output of an OCR tool and transmit data to generate representation data of a page according to embodiments, as described herein.

Processor 602 may also be operatively coupled to a storage device 608. Storage device 608 may be any computer-operated hardware suitable for storing and/or retrieving data, such as, but not limited to, data associated with historic databases. In some embodiments, storage device 608 may be integrated in the application server 600. For example, the application server 600 may include one or more hard disk drives as storage device 608.

In other embodiments, storage device 608 may be external to host computing device 600 and may be accessed by a plurality of user devices 500. For example, storage device 608 may include a storage area network (SAN), a network attached storage (NAS) system, and/or multiple storage units such as hard disks and/or solid-state disks in a redundant array of inexpensive disks (RAID) configuration.

In some embodiments, processor 602 may be operatively coupled to storage device 508 via a storage interface 610. Storage interface 610 may be any component capable of providing processor 602 with access to storage device 608. Storage interface 610 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 602 with access to storage device 608.

Processor 602 may execute computer-executable instructions for implementing aspects of the disclosure. In some embodiments, the processor 602 may be transformed into a special purpose microprocessor by executing computer-executable instructions or by otherwise being programmed. In some embodiments, and by way of a non-limiting example, the memory 604 may include instructions to perform specific operations, as described herein.

### Exemplary Computer-Implemented Method

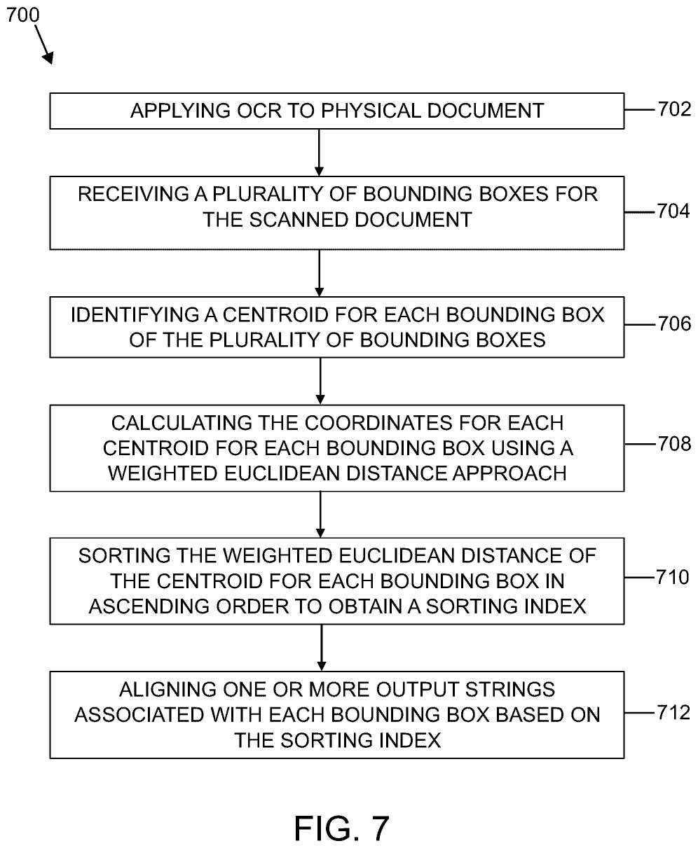

FIG. 7 depicts a flow-chart 700 of example computer-implemented method operations performed by the spatial alignment computer system 600 for string alignment within a document processed using an optical character recognition (OCR) tool of any type or version. The spatial alignment computer system 600 may include at least one memory, and at least one processor in communication with the at least one memory. The at least one processor may be programmed to perform the steps or operations described herein.

The method and/or operations may include applying 702 an optical character recognition (OCR) tool to a physical document so as to convert the physical document into a digital document. The OCR tools used may be of different types and/or versions. The method further includes receiving 704 a plurality of bounding boxes of the scanned document from the OCR tool. The AI OCR tool is configured to scan the physical document and generate a digital document that includes the plurality of bounding boxes that define strings of text that are presented in the digital document.

The method may further include identifying 706 a centroid of each bounding box of the plurality of bounding boxes, and calculating 708 the coordinates for each centroid of each bounding box of the plurality of bounding boxes using a weighted Euclidean distance approach. The spatial alignment computer system calculates 708 the coordinates for each centroid of each bounding box of the plurality of bounding boxes by determining a reference point defined at a top-left corner of the document page in which the one or more aligned output strings are displayed.

In the example embodiment, a vertical coordinate component of the calculated coordinates for each centroid of each bounding box of the plurality of bounding boxes is more heavily weighted than a horizontal coordinate component. The vertical spacing between two rows of the document displaying the one or more aligned output strings is determined based at least in part on a paper size of the document. In the example embodiment, the paper size of the document may include at least one of: (i) a letter size; (ii) a legal size; (iii) a tabloid size; (iv) a ledger size; (v) a junior legal size; (vi) a half letter size; (vii) a government letter; or (viii) a government legal size. The vertical spacing between two rows of the document displaying the one or more aligned output strings is further determined based at least in part on a font type or a font size.

The spatial alignment computer system 600 is also configured to calculate the coordinates of the centroid by certain weights. For example, a weight ω₂ of a vertical coordinate component of the calculated coordinates of the centroid of each bounding box of the plurality of bounding boxes is at least

$${( \frac{rh}{Δ h} )}^{2}$$

times a weight ω₁ of a horizontal coordinate component of the calculated coordinates of the centroid of each bounding box of the plurality of bounding boxes, wherein h corresponds with a length of a document page, r corresponds with an aspect ratio of 1/\sqrt{2} and Δh corresponds with a height of a single line or row.

The method further includes sorting 710 the weighted Euclidean distance of the centroid of each bounding box in ascending order to obtain a sorting index; and based upon the sorting index, aligning 712 one or more output strings associated with each bounding box of the plurality of bounding boxes.

As described herein, these steps may be performed using two or more different OCR tools (e.g., either two different tools or two different versions of the same tool) so that the output strings from the different OCR tools so that the outputs from the two different OCR tools can be compared for performance purposes. The spatial alignment system 600 is configured to generate a digital document from a scanned physical or original document using any OCR tool wherein the output strings from any two different OCR tools (e.g., either two different tools or two different versions of the same tool) are similarly aligned in the digital document and more accurately represents the information included in the original document. The system and method described herein allows for improved comparisons between the outputs from different OCR tools. For example, if the spatial alignment system 600 outputs strings using two different OCR versions that are generally aligned, then those two OCR tool versions may be considered compatible with one another. If, however, the spatial alignment system 600 outputs strings from two different OCR versions that are not aligned or have other differences between their outputs, then those two OCR tool versions may be considered or labeled not compatible. Further review of the OCR tools may then be needed to determine the cause of the differences between the outputs. In some cases, it may be determined that only those OCR tools that generate similar outputs via the spatial alignment system 600 will be used by an enterprise and those OCR tools that generate different outputs will be avoided.

The spatial alignment computer system 600 and/or user device 500 may perform one or more operations of various operations, and/or one or more actions of the additional actions in accordance with one or more generative AI models, as described herein. The spatial alignment computer system 600 may perform one or more operations described herein in accordance with one or more generative AI models.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the spatial alignment computer system 600 is configured to implement machine learning, such that a computer system “learns” to analyze, organize, and/or process data without being explicitly programmed. Machine learning may be implemented through machine learning methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images and/or text or text strings. ML outputs may include, but are not limited to identified text strings, objects, items classifications, and/or other data extracted from the images or text. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features or with a large sample of other data with known characteristics or features. Such information may include, for example, information associated with a plurality of images or text and/or other data of a plurality of different objects, items, and/or property including appliances and/or other systems.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may include voice bots or chatbots that are configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption. The voice bots or chatbots may be used to conduct the OCR of a physical document and then help to align the text strings for the digital document in accordance with the present disclosure.

Based upon these analyses, the processing element may learn how to identify characteristics and patterns that may then be applied to analyzing and classifying objects and/or text.

### Additional Exemplary Embodiments

Additional exemplary embodiments of the systems and methods described herein are provided herein. For example, in one embodiment, a spatial alignment computer system for string alignment within a document processed using an OCR tool may include at least one memory and at least one processor in communication with the at least one memory. The at least one processor may be programmed to: (i) receive a plurality of bounding boxes of a document scanned using an OCR tool, (ii) identify a centroid of each bounding box of the plurality of bounding boxes, (iii) calculate coordinates for each centroid of each bounding box of the plurality of bounding boxes using a weighted Euclidean distance approach, (iv) sort the weighted Euclidean distance of the centroid of each bounding box in ascending order to obtain a sorting index, and (v) based upon the sorting index, align one or more output strings associated with each bounding box of the plurality of bounding boxes.

In another embodiment, the spatial alignment computer system in accordance with any of the preceding aspects may further include wherein the coordinates for each centroid of each bounding box of the plurality of bounding boxes are determined from a reference point defined at a top-left corner of a document page in which the one or more aligned output strings are displayed.

In another embodiment, the spatial alignment computer system in accordance with any of the preceding aspects may further include wherein a vertical coordinate component of the calculated coordinates for each centroid of each bounding box of the plurality of bounding boxes is more heavily weighted than a horizontal coordinate component.

In another embodiment, the spatial alignment computer system in accordance with any of the preceding aspects may further include wherein the vertical spacing between two rows of a document displaying the one or more aligned output strings is determined based at least in part on a paper size of the document.

In another embodiment, the spatial alignment computer system in accordance with any of the preceding aspects may further include wherein the paper size of the document includes at least one of: (i) a letter size; (ii) a legal size; (iii) a tabloid size; (iv) a ledger size; (v) a junior legal size; (vi) a half letter size; (vii) a government letter; or (viii) a government legal size.

In another embodiment, the spatial alignment computer system in accordance with any of the preceding aspects may further include wherein the vertical spacing between two rows of the document displaying the one or more aligned output strings is further determined based at least in part on a font type or a font size.

In another embodiment, the spatial alignment computer system in accordance with any of the preceding aspects may further include calculating the coordinates of the centroids by applying certain weights. For example, the weights may include a weight ω₂ of a vertical coordinate component of the calculated coordinates of the centroid of each bounding box of the plurality of bounding boxes that is at least

$${( \frac{rh}{Δ h} )}^{2}$$

times a weight ω₁ of a horizontal coordinate component of the calculated coordinates of the centroid of each bounding box of the plurality of bounding boxes, wherein h corresponds with a length of a document page, r corresponds with an aspect ratio of 1/\sqrt{2} and Δh corresponds with a height of a single line or row.

In another embodiment, the spatial alignment computer system in accordance with any of the preceding aspects may further include wherein the at least one processor is further programmed to: (i) based upon the sorting index for a first version of the OCR tool, align a first set of one or more output strings associated with each bounding box of a plurality of bounding boxes generated by the first version of the OCR tool; (ii) based upon a sorting index for a second version of the OCR tool, align a second set of one or more output strings associated with each bounding box of a plurality of bounding boxes generated by the second version of the OCR tool; (iii) compare the spatial alignment of the first set of the one or more output strings to the second set of the one or more output strings; and (iv) output a performance metric indicating how the first version of the OCR tool compares to the second version of the OCR tool.

In another embodiment, the spatial alignment computer system in accordance with any of the preceding aspects may further include wherein the performance metric indicates whether the spatial alignments of the different versions of the OCR tools are compatible or non-compatible.

In another embodiment, the spatial alignment computer system in accordance with any of the preceding aspects may further include wherein the at least one processor is further programmed to: (i) compare the alignment of the one or more output strings from a first version of the OCR tool to an alignment of one or more output strings from a second version of an OCR tool; and (ii) determine from the comparison whether the first version and the second version of the OCR tools are compatible.

In another aspect, a computer-implemented method for string alignment within a document processed using an optical character recognition (OCR) tool is provided. The method implemented using a computing device including at least one processor and at least one memory. The computer-implemented method comprising receiving a plurality of bounding boxes of a document scanned using an OCR tool; identifying a centroid of each bounding box of the plurality of bounding boxes; calculating coordinates for each centroid of each bounding box of the plurality of bounding boxes using a weighted Euclidean distance approach; sorting the weighted Euclidean distance of the centroid of each bounding box in ascending order to obtain a sorting index; and based upon the sorting index, aligning one or more output strings associated with each bounding box of the plurality of bounding boxes.

In another embodiment, the computer-implemented method in accordance with any of the preceding aspects may further include wherein the coordinates for each centroid of each bounding box of the plurality of bounding boxes are determined from a reference point defined at a top-left corner of a document page in which the one or more aligned output strings are displayed.

In another embodiment, the computer-implemented method in accordance with any of the preceding aspects may further include wherein a vertical coordinate component of the calculated coordinates for each centroid of each bounding box of the plurality of bounding boxes is more heavily weighted than a horizontal coordinate component.

In another embodiment, the computer-implemented method in accordance with any of the preceding aspects may further include wherein a vertical spacing between two rows of a document displaying the one or more aligned output strings is determined based at least in part on a paper size of the document.

In another embodiment, the computer-implemented method in accordance with any of the preceding aspects may further include wherein a weight ω₂ of a vertical coordinate component of the calculated coordinates of the centroid of each bounding box of the plurality of bounding boxes is at least

$${( \frac{rh}{Δ h} )}^{2}$$

times a weight ω₁ of a horizontal coordinate component of the calculated coordinates of the centroid of each bounding box of the plurality of bounding boxes, wherein h corresponds with a length of a document page, r corresponds with an aspect ratio of 1/\vec{2} and Δh corresponds with a height of a single line or row.

In another embodiment, the computer-implemented method in accordance with any of the preceding aspects may further include (i) based upon the sorting index for a first version of the OCR tool, aligning a first set of one or more output strings associated with each bounding box of a plurality of bounding boxes generated by the first version of the OCR tool; (ii) based upon a sorting index for a second version of the OCR tool, aligning a second set of one or more output strings associated with each bounding box of a plurality of bounding boxes generated by the second version of the OCR tool; (iii) comparing the spatial alignment of the first set of the one or more output strings to the second set of the one or more output strings; and (iv) outputting a performance metric indicating how the first version of the OCR tool compares to the second version of the OCR tool.

In another embodiment, the computer-implemented method in accordance with any of the preceding aspects may further include wherein the performance metric indicates whether the spatial alignments of the different versions of the OCR tools are compatible or non-compatible.

In another embodiment, the computer-implemented method in accordance with any of the preceding aspects may further include comparing the alignment of the one or more output strings from a first version of the OCR tool to an alignment of one or more output strings from a second version of an OCR tool; and determining from the comparison whether the first version and the second version of the OCR tools are compatible.

In another aspect, a non-transitory computer-readable storage medium having computer-executable instructions stored thereon is provided. Wherein when executed by a processor of a spatial alignment computer system for string alignment within a document processed using an optical character recognition (OCR) tool, the computer-executable instructions cause the processor to: receive a plurality of bounding boxes of a document scanned using an OCR tool; identify a centroid of each bounding box of the plurality of bounding boxes; calculate coordinates for each centroid of each bounding box of the plurality of bounding boxes using a weighted Euclidean distance approach; sort the weighted Euclidean distance of the centroid of each bounding box in ascending order to obtain a sorting index; and based upon the sorting index, align one or more output strings associated with each bounding box of the plurality of bounding boxes.

In another embodiment, the non-transitory computer-readable storage medium in accordance with any of the preceding aspects may further include wherein a weight ω₂ of a vertical coordinate component of the calculated coordinates of the centroid of each bounding box of the plurality of bounding boxes is at least

$${( \frac{rh}{Δ h} )}^{2}$$

times a weight ω₁ of a horizontal coordinate component of the calculated coordinates of the centroid of each bounding box of the plurality of bounding boxes, wherein h corresponds with a length of a document page, r corresponds with an aspect ratio of 1/\sqrt{2} and Δh corresponds with a height of a single line or row.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A spatial alignment computer system for string alignment within a document processed using an optical character recognition (OCR) tool, the spatial alignment computer system comprising:
at least one memory; and
at least one processor in communication with the at least one memory, wherein the at least one processor is programmed to:
receive a plurality of bounding boxes of a document scanned using an OCR tool;
identify a centroid of each bounding box of the plurality of bounding boxes;
calculate coordinates for each centroid of each bounding box of the plurality of bounding boxes using a weighted Euclidean distance approach;
sort the weighted Euclidean distance of the centroid of each bounding box in ascending order to obtain a sorting index; and
based upon the sorting index, align one or more output strings associated with each bounding box of the plurality of bounding boxes.

2. The spatial alignment computer system of claim 1, wherein the coordinates for each centroid of each bounding box of the plurality of bounding boxes are determined from a reference point defined at a top-left corner of a document page in which the one or more aligned output strings are displayed.

3. The spatial alignment computer system of claim 1, wherein a vertical coordinate component of the calculated coordinates for each centroid of each bounding box of the plurality of bounding boxes is more heavily weighted than a horizontal coordinate component.

4. The spatial alignment computer system of claim 1, wherein a vertical spacing between two rows of a document displaying the one or more aligned output strings is determined based at least in part on a paper size of the document.

5. The spatial alignment computer system of claim 4, wherein the paper size of the document includes at least one of: (i) a letter size; (ii) a legal size; (iii) a tabloid size; (iv) a ledger size; (v) a junior legal size; (vi) a half letter size; (vii) a government letter; or (viii) a government legal size.

6. The spatial alignment computer system of claim 4, wherein the vertical spacing between two rows of the document displaying the one or more aligned output strings is further determined based at least in part on a font type or a font size.

7. The spatial alignment computer system of claim 1, wherein a weight ω₂ of a vertical coordinate component of the calculated coordinates of the centroid of each bounding box of the plurality of bounding boxes is at least
$${( \frac{rh}{Δ h} )}^{2}$$
times a weight ω₁ of a horizontal coordinate component of the calculated coordinates of the centroid of each bounding box of the plurality of bounding boxes, wherein h corresponds with a length of a document page, r corresponds with an aspect ratio of 1/\sqrt{2} and Δh corresponds with a height of a single line or row.

8. The spatial alignment computer system of claim 1, wherein the at least one processor is further programmed to:
based upon the sorting index for a first version of the OCR tool, align a first set of one or more output strings associated with each bounding box of a plurality of bounding boxes generated by the first version of the OCR tool;
based upon a sorting index for a second version of the OCR tool, align a second set of one or more output strings associated with each bounding box of a plurality of bounding boxes generated by the second version of the OCR tool;
compare the spatial alignment of the first set of the one or more output strings to the second set of the one or more output strings; and
output a performance metric indicating how the first version of the OCR tool compares to the second version of the OCR tool.

9. The spatial alignment computer system of claim 8, wherein the performance metric indicates whether the spatial alignments of the different versions of the OCR tools are compatible or non-compatible.

10. The spatial alignment computer system of claim 1, wherein the at least one processor is further programmed to:
compare the alignment of the one or more output strings from a first version of the OCR tool to an alignment of one or more output strings from a second version of an OCR tool; and
determine from the comparison whether the first version and the second version of the OCR tools are compatible.

11. A computer-implemented method for string alignment within a document processed using an optical character recognition (OCR) tool, the method implemented using a computing device including at least one processor and at least one memory, the computer-implemented method comprising:
receiving a plurality of bounding boxes of a document scanned using an OCR tool;
identifying a centroid of each bounding box of the plurality of bounding boxes;
calculating coordinates for each centroid of each bounding box of the plurality of bounding boxes using a weighted Euclidean distance approach;
sorting the weighted Euclidean distance of the centroid of each bounding box in ascending order to obtain a sorting index; and
based upon the sorting index, aligning one or more output strings associated with each bounding box of the plurality of bounding boxes.

12. The computer-implemented method of claim 11, wherein the coordinates for each centroid of each bounding box of the plurality of bounding boxes are determined from a reference point defined at a top-left corner of a document page in which the one or more aligned output strings are displayed.

13. The computer-implemented method of claim 11, wherein a vertical coordinate component of the calculated coordinates for each centroid of each bounding box of the plurality of bounding boxes is more heavily weighted than a horizontal coordinate component.

14. The computer-implemented method of claim 11, wherein a vertical spacing between two rows of a document displaying the one or more aligned output strings is determined based at least in part on a paper size of the document.

15. The computer-implemented method of claim 11, wherein a weight ω₂ of a vertical coordinate component of the calculated coordinates of the centroid of each bounding box of the plurality of bounding boxes is at least
$${( \frac{rh}{Δ h} )}^{2}$$
times a weight ω₁ of a horizontal coordinate component of the calculated coordinates of the centroid of each bounding box of the plurality of bounding boxes, wherein h corresponds with a length of a document page, r corresponds with an aspect ratio of 1/\sqrt{2}, and Δh corresponds with a height of a single line or row.

16. The computer-implemented method of claim 11, wherein the method further comprises:
based upon the sorting index for a first version of the OCR tool, aligning a first set of one or more output strings associated with each bounding box of a plurality of bounding boxes generated by the first version of the OCR tool;
based upon a sorting index for a second version of the OCR tool, aligning a second set of one or more output strings associated with each bounding box of a plurality of bounding boxes generated by the second version of the OCR tool;
comparing the spatial alignment of the first set of the one or more output strings to the second set of the one or more output strings; and
outputting a performance metric indicating how the first version of the OCR tool compares to the second version of the OCR tool.

17. The computer-implemented method of claim 16, wherein the performance metric indicates whether the spatial alignments of the different versions of the OCR tools are compatible or non-compatible.

18. The computer-implemented method of claim 11, wherein the method further comprises:
comparing the alignment of the one or more output strings from a first version of the OCR tool to an alignment of one or more output strings from a second version of an OCR tool; and
determining from the comparison whether the first version and the second version of the OCR tools are compatible.

19. A non-transitory computer-readable storage medium having computer-executable instructions stored thereon, wherein when executed by a processor of a spatial alignment computer system for string alignment within a document processed using an optical character recognition (OCR) tool, the computer-executable instructions cause the processor to:
receive a plurality of bounding boxes of a document scanned using an OCR tool;
identify a centroid of each bounding box of the plurality of bounding boxes;
calculate coordinates for each centroid of each bounding box of the plurality of bounding boxes using a weighted Euclidean distance approach;
sort the weighted Euclidean distance of the centroid of each bounding box in ascending order to obtain a sorting index; and
based upon the sorting index, align one or more output strings associated with each bounding box of the plurality of bounding boxes.

20. The non-transitory computer-readable storage medium of claim 19, wherein a weight ω₂ of a vertical coordinate component of the calculated coordinates of the centroid of each bounding box of the plurality of bounding boxes is at least
$${( \frac{rh}{Δ h} )}^{2}$$
times a weight ω₁ of a horizontal coordinate component of the calculated coordinates of the centroid of each bounding box of the plurality of bounding boxes, wherein h corresponds with a length of a document page, r corresponds with an aspect ratio of 1/\sqrt{2}, and Δh corresponds with a height of a single line or row.
